(19) United States
(12) Patent Application Publication
(10) Pub. No.: US 2026/0221361 A1
(43) Pub. Date: Jul. 30, 2026

(54) HIGH CURRENT RELAY MODULE AND ELECTRICAL SYSTEM

(71) Applicant: Lear Corporation, Southfield, MI (US)

(72) Inventors: Luis Miguel Muñoz Garcia, Valls (ES); Marc Miro Bargallo, Valls (ES); Glòria Simó Quinoñero, Valls (ES); Adrià Crusells Porras, Valls (ES)

(21) Appl. No.: 19/037,943

(22) Filed: Jan. 27, 2025

(51) Int. Cl. H01H 50/04; B60R 16/023; H01H 50/14

(52) U.S. Cl. CPC H01H 50/041; B60R 16/0238; H01H 50/14

(57) ABSTRACT

A high current relay module may include a housing, a plurality of busbars disposed at least partially in the housing, and a plurality of relays disposed in the housing. The plurality of relays may include a first relay via which a first subset of the plurality of busbars are selectively electrically connectable. The plurality of relays may include a second relay via which a second subset of the plurality of busbars are selectively electrically connectable. The housing and the plurality of busbars may each be connectable to a printed circuit board.

### TECHNICAL FIELD

The present disclosure generally relates to high current relay modules that may, for example, be utilized in connection with and/or incorporated in vehicles (e.g., hybrid and/or electrical vehicles), one or more electrical systems of such vehicles, and/or power distribution boxes of such vehicles. The present disclosure also generally relates to electrical systems including such high current relay modules.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a simplified schematical diagram of an embodiment of an electrical system including a high current relay module according to teachings of the present disclosure.

FIG. 2 is a perspective view of an embodiment of a high current relay module according to teachings of the present disclosure.

FIG. 3 is a perspective view of an embodiment of a printed circuit board (PCB) interface of a busbar according to teachings of the present disclosure.

FIG. 4 is a simplified schematical diagram of an electrical system including another embodiment of a high current relay module according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

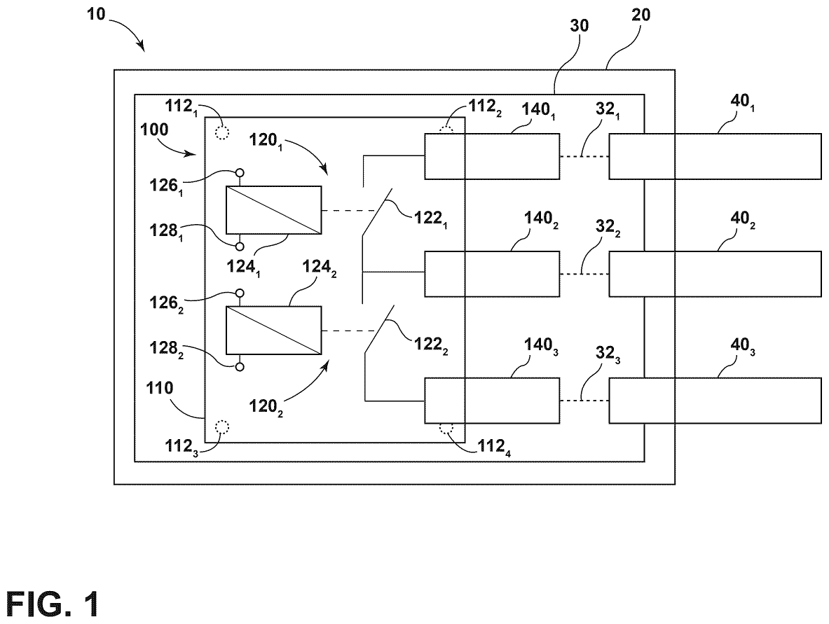

Depicted in the FIG. 1 is an electrical system 10, which may be incorporated into and/or a component of a vehicle (e.g., a hybrid and/or electrical vehicle) and/or a power distribution box of said vehicle. The electrical system 10 includes a housing 20 (e.g., an outer housing and/or enclosure), at least one printed circuit board (PCB) 30, a plurality of busbars (e.g., a first busbar 40₁, a second busbar 40₂, a third busbar 40₃), and a high current relay module 100. The relay module 100 is configured to selectively transfer and/or distribute energy (e.g., electrical energy and/or electricity) to and/or between one or more ports (e.g., of a vehicle) that are connected to the busbars 40₁, 40₂, 40₃. The relay module 100 includes a plurality of relays 120₁, 120₂ that are disposed within a common housing 110 that is (e.g., directly) connectable (e.g., solderable) to the PCB 30. The relay module 100 also includes a plurality of busbars 140₁, 140₂, 140₃ that extend and/or project out of the housing 110 and are (e.g., directly) connectable (e.g., solderable) to the PCB 30. As such, the relay module 100 is able to be provided as a singular package that can be directly connected (e.g., soldered) to the PCB 30. For clarity, the busbars 40₁, 40₂, 40₃ may also be referred to and/or claimed as additional and/or port busbars 40₁, 40₂, 40₃, and the busbars 140₁, 140₂, 140₃ of the relay module 100 may also be referred to and/or claimed as module busbars 140₁, 140₂, 140₃.

Compared to conventional electrical system designs that utilize several separate/individual relays connected to a circuit board by additional, separate components (e.g., interconnection busbars), the relay module 100 may take up less space, cover a smaller surface area of the PCB 30 (i.e., has a smaller footprint on the PCB 30), and/or can be mounted on the PCB 30 in a simplified and more cost and time effective manner. The relay module 100 can therefore provide significant advantages with respect to space utilization (e.g., 25% less space utilized by the relay module 100 than by two commercially available relays) and production/assembly time, cost, and/or complexity. Moreover, due to the relay module 100, the electrical system 10 does not include, utilize, and/or require additional components (e.g., interconnection busbars) to connect the relays 120₁, 120₂ to the PCB 30, nor a heat sink that are common in conventional electrical system designs. The system 10 may therefore include fewer components than conventional electrical system designs, which can provide the system 10 with a simplified and/or less complex design and lower weight, material usage, and/or production/assembly time and cost relative to conventional electrical system designs. An absence of interconnection busbars in the system 10 may also reduce the number of electrical connections and, consequently, the system 10 may have a lower and/or reduced thermal output (e.g., less heat generation) relative to conventional electrical system designs and renders a heat sink unnecessary.

As generally illustrated in FIG. 1, the housing 20 is a body (e.g., a plastic, metal, and/or composite box or similar structure) that encloses and protects one or more other components of the system 10. The PCB 30, port busbars 40₁, 40₂, 40₃, and relay module 100 are disposed at least partially within and at least partially enclosed by the housing 20. The PCB 30 is connected both physically and electrically to the relay module 100 and each of the port busbars 40₁, 40₂, 40₃. The PCB 30 includes a plurality of conductors and/or tracks (e.g., a first track 32₁, a second track 32₂, a third track 32₃) that electrically connect the port busbars 40₁, 40₂, 40₃ and the relay module 100. The port busbars 40₁, 40₂, 40₃ each project out of the housing 20 (e.g., via one or more openings and/or recesses disposed in and/or defined by the housing 20) such that each port busbar 40₁, 40₂, 40₃ is disposed partially inside the housing 20 and partially outside of the housing 20. The port busbars 40₁, 40₂, 40₃ may each form, define, and/or be considered an input/output (i/o) terminal of the system 10, and may be connectable to one or more ports (e.g., of a vehicle). The port busbars 40₁, 40₂, 40₃ may each be connected to different ports. For example, the first, second, and third port busbar 40₁, 40₂, 40₃ may be connectable and/or connected to a first port, a second port, and a third port, respectively.

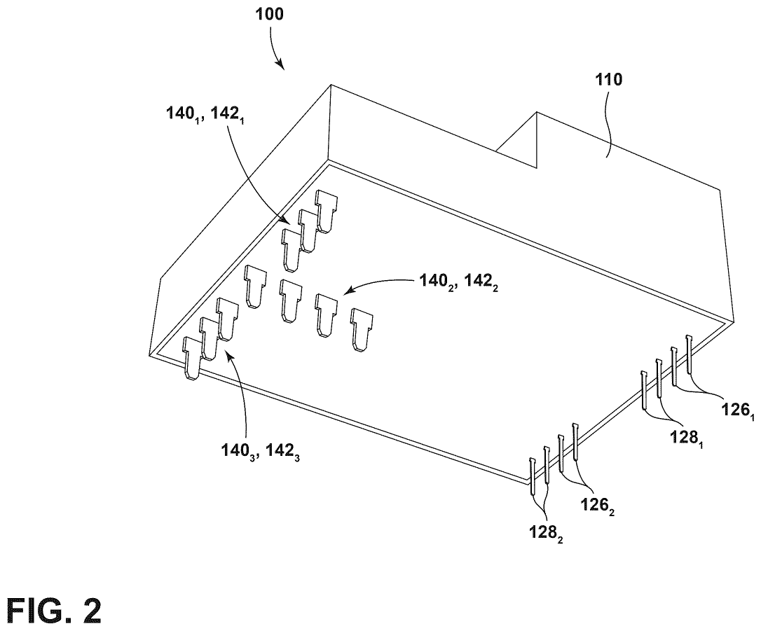

As generally illustrated in FIGS. 1 and 2, the relay module 100 includes a housing 100 (e.g., a module housing), a plurality of individually operatable relays (e.g., a first relay 120₁, a second relay 120₂), and a plurality of busbars (e.g., a first busbar 140₁, a second busbar 140₂, a third busbar 140₃). In embodiments, relay module 100 is mounted on the PCB 30 (e.g., via the housing 110) and is electrically connected to the PCB 30, the tracks 32₁, 32₂, 32₃, the additional busbars 40₁, 40₂, 40₃, and/or the ports (e.g., via the busbars 140₁, 140₂, 140₃).

As generally illustrated in FIGS. 1 and 2, the housing 110 is a body (e.g., a plastic, metal, and/or composite box or similar structure) that encloses and protects one or more other components of the relay module 100. The relays 120₁, 120₂ and the busbars 140₁, 140₂, 140₃ are disposed at least partially within and are at least partially enclosed by the housing 110. The housing 110 includes a plurality of projections (e.g., a first projection 112₁, second projection 112₂, third projection 112₃, and fourth projection 112₄) via which the housing 110 and/or the relay module 100 is (e.g., directly) connectable and/or connected to the PCB 30. The projections 112₁, 112₂, 112₃, 112₄ are disposed on and project from an exterior surface (e.g., of a bottom wall) of the housing 110. The projections 112₁, 112₂, 112₃, 112₄ are directly connected (e.g., soldered) and/or connectable (e.g., solderable) to the PCB 30 for securing and/or mounting the housing 110 and the relay module 100 on the PCB 30. The projections 112₁, 112₂, 112₃, 112₄ are cylindrical bodies that are each disposed at or about a respective corner of a bottom wall of the housing 110 in the illustrative example depicted in the FIG. 1, though other configurations and arrangements of projections 112₁, 112₂, 112₃, 112₄ are conceivable. The projections 112₁, 112₂, 112₃, 112₄ are not depicted in FIG. 2 to provide an unobstructed view of the busbars 140₁, 140₂, 140₃, the PCB interfaces 142₁, 142₂, 142₃, and the electrical contacts 126₁, 128₁, 126₂, 128₂.

As generally illustrated in FIG. 1, the relay module 100 includes a plurality of relays 120₁, 120₂ configured to selectively electrically connect a respective subset of the busbars 140₁, 140₂, 140₃. The relays 120₁, 120₂ each include a switch 122₁, 122₂ and an actuator 124₁, 124₂ configured to actuate the switch 122₁, 122₂. The actuators 124₁, 124₂ may each include and/or be configured as a coil. The switches 122₁, 122₂ are each adjustable to a plurality of different states and/or positions. When a switch 122₁, 122₂ is in a closed state, at least two busbars of the associated subset of busbars are electrically connected to one another via the switch 122₁, 122₂. When a switch 122₁, 122₂ is in an open state, at least two busbars of the associated subset of busbars are not electrically connected to one another via the switch 122₁, 122₂. When multiple switches 122₁, 122₂ are in the closed state, one or more busbars from one subset of the busbars (e.g., the first busbar 140₁) may be electrically connected to one or more busbars of a different subset of busbars (e.g., the third busbar 140₃) via the switches 122₁, 122₂ that are in the closed state. The relays 120₁, 120₂ and/or the actuators 124₁, 124₂ thereof are operable independently of one another such that the state and/or position of each switch 122₁, 122₂ is adjustable independently (e.g., of the state and/or position of the other switch 122₁, 122₂). The relays 120₁, 120₂ may be controlled by and connected physically and/or electrically to one or more electrical circuits. In some examples, the relays 120₁, 120₂ are connectable and/or connected to different electrical circuits and are controllable independently of one another by different electrical circuits. The relays 120₁, 120₂ and/or the actuators 124₁, 124₂ may each include one or more electrical contacts 126₁, 128₁, 126₂, 128₂ (e.g., signal terminals) via which the respective relay 120₁, 120₂ and/or the actuator 124₁, 124₂ thereof is connectable to an electrical circuit. The electrical circuits (e.g., the first electrical circuit and the second electrical circuit) are each connected to and/or controlled by one or more electronic control units (ECU) (e.g., of a vehicle).

The relay module 100 includes two relays—a first relay 120₁ and a second relay 120₂—in the illustrative example, though other quantities/numbers of relays are conceivable. A first subset of the plurality of busbars (e.g., the first and second busbars 140₁, 140₂) are selectively electrically connectable via the first relay 120₁. A different, second subset of the plurality of busbars (e.g., the second and third busbars 140₂, 140₃) are selectively electrically connectable via the second relay 120₂.

The first relay 120₁ is connected to the first and second busbars 140₁, 140₂ (i.e., a first subset of the plurality of busbars) and is configured to selectively electrically connect the first and second busbars 140₁, 140₂ to one another. The first relay 120₁ includes a first switch 122₁ and a first actuator 124₁ configured to actuate the first switch 122₁. The first actuator 124₁, in some examples, includes and/or is configured as a first coil. The first switch 122₁ is actuatable and/or adjustable to a closed state and to an open state via the first actuator 124₁. When the first switch 122₁ is in the closed state, the first and second busbars 140₁, 140₂ are electrically connected to one another via the first switch 122₁. When the first switch 122₁ is in the open state, the first and second busbars 140₁, 140₂ are not electrically connected to one another via the first switch 122₁. When the first switch 122₁ and the second switch 122₂ are both in the closed state, the first, second, and third busbars 140₁, 140₂, 140₃ are electrically connected to one another via the first and second switches 122₁, 122₂. The first relay 120₁ includes a first electrical contact 126₁ and a second electrical contact 128₁ via which the first relay 120₁ and/or the first actuator 124₁ is connectable and/or connected to a first electrical circuit. The first relay 120₁ is operable via the first circuit independently of the second relay 120₂, which is connected to and controlled by a different second circuit. The first relay 120₁ and/or the first actuator 124₁ (e.g., first coil) is disposed and/or included in the first circuit. To control the first relay 120₁, the first circuit may selectively supply electrical energy to the first relay 120₁ and/or the first actuator 124₁. The electrical energy supplied by the first circuit may flow through the first actuator 124₁ (e.g., the first coil), which may actuate the first switch 122₁ to adjust a state of the first switch 122₁, such as from the open state to the closed state and/or vice versa. The first switch 122₁ may automatically return to the previous state (e.g., the open state and/or the closed state) when the first circuit stops providing a sufficient amount of electrical energy to the first relay 120₁ and/or when a sufficient amount of electrical energy is no longer flowing through the first relay 120₁ and/or the first actuator 124₁. Alternatively, the first actuator 124₁ may be operated by short voltage pulses and the first switch 122₁ may remain in its current state (e.g., the open state and/or the closed state), even when the first circuit is not providing electrical energy to the first relay 120₁ and/or the first actuator 124₁, until the first actuator 124₁ receives a voltage pulse that adjusts the first switch 122₁ to the other state (e.g., to the open state and/or the closed state).

The second relay 120₂ is connected to the second and third busbars 140₂, 140₃ (i.e., a second subset of the plurality of busbars) and is configured to selectively electrically connect the second and third busbars 140₂, 140₃ to one another. The second relay 120₂ includes a second switch 122₂ and a second actuator 124₂ configured to actuate the second switch 122₂. The second actuator 124₂, in some examples, includes and/or is configured as a second coil. The second switch 122₂ is adjustable to a closed state and to an open state via the second actuator 124₂. When the second switch 122₂ is in the closed state, the second and third busbars 140₂, 140₃ are electrically connected to one another via the second switch 122₂. When the second switch 122₂ is in the open state, the second and third busbars 140₂, 140₃ are not electrically connected to one another via the second switch 122₂. When the first switch 122₁ and the second switch 122₂ are both in the closed state, the first, second, and third busbars 140₁, 140₂, 140₃ are electrically connected to one another via the first and second switches 122₁, 122₂. The second relay 120₂ includes a first electrical contact 126₂ and a second electrical contact 128₂ via which the second relay 120₂ and/or the second actuator 124₂ is connectable and/or connected to a second electrical circuit. The second relay 120₂ is operable via the second circuit independently of the first relay 120₁, which is connected to and controlled by the first circuit. The second relay 120₂ and/or the second actuator 124₂ (e.g., second coil) is disposed and/or included in the second circuit. To control the second relay 120₂, the second circuit may selectively supply electrical energy to the second relay 120₂ and/or the second actuator 124₂. The electrical energy supplied by the second circuit may flow through the second actuator 124₂ (e.g., the second coil), which may actuate the second switch 122₂ to adjust a state of the second switch 122₂, such as from the open state to the closed state and/or vice versa. The second switch 122₂ may automatically return to the previous state (e.g., the open state and/or the closed state) when the second circuit stops providing a sufficient amount of electrical energy to the second relay 120₂ and/or when a sufficient amount of electrical energy is no longer flowing through the second relay 120₂ and/or the second actuator 124₂. Alternatively, the second actuator 124₂ may be operated by short voltage pulses and the second switch 122₂ may remain in its current state (e.g., the open state and/or the closed state), even when the second circuit is not providing electrical energy to the second relay 120₂ and/or the second actuator 124₂, until the second actuator 124₂ receives a voltage pulse that adjusts the second switch 122₂ to the other state (e.g., to the open state and/or the closed state).

As generally illustrated in FIG. 1, the relay module 100 includes three busbars, a first busbar 140₁, a second busbar 140₂, and a third busbar 140₃, though other quantities/numbers of busbars are envisioned by this disclosure. The busbars 140₁, 140₂, 140₃ each project out of the housing 110 such that each busbar 140₁, 140₂, 140₃ is disposed partially inside the housing 110 and partially outside of the housing 110. The busbars 140₁, 140₂, 140₃ may each form, define, and/or be considered a power terminal of the relay module 100, and may be connectable to one or more tracks 32₁, 32₂, 32₃ of the PCB 30. A first end and/or a first portion of each busbar 140₁, 140₂, 140₃ disposed outside of the housing 110 is connected to the PCB 30 and/or one or more tracks 32₁, 32₂, 32₃ thereof. An opposite, second end and/or a second portion of each busbar 140₁, 140₂, 140₃ disposed inside of the housing 110 is connected to one or more relays 120₁, 120₂ and is selectively connectable to one or more of the other busbars 140₁, 140₂, 140₃.

The busbars 140₁, 140₂, 140₃ are each connected physically and/or electrically to one or more relays 120₁, 120₂ and are each selectively connectable to one or more of the other busbars 140₁, 140₂, 140₃. The first busbar 140₁ is physically and/or electrically connected to the first relay 120₁. The first busbar 140₁ is selectively electrically connected to the second busbar 140₂ via the first switch 122₁ of the first relay 120₁ and is selectively electrically connected to the third busbar 140₃ via the first switch 122₁ of the first relay 120₁, the second busbar 140₂, and the second switch 122₂ of the second relay 120₂. The second busbar 140₂ is physically and/or electrically connected to the first relay 120₁ and the second relay 120₂. The second busbar 140₂ is selectively electrically connected to the first busbar 140₁ via the first switch 122₁ of the first relay 120₁ and is selectively electrically connected to the third busbar 140₃ via the second switch 122₂ of t he second relay 120₂. The third busbar 140₃ is physically and/or electrically connected to the second relay 120₂. The third busbar 140₃ is selectively electrically connected to the second busbar 140₂ via the second switch 122₂ of the second relay 120₂ and is selectively electrically connected to the first busbar 140₁ via the second switch 122₂ of the second relay 120₂, the second busbar 140₂, and the first switch 122₁ of the first relay 120₁.

The busbars 140₁, 140₂, 140₃ are each connected physically and/or electrically to the PCB 30 and/or the tracks 32₁, 32₂, 32₃ thereof. The busbars 140₁, 140₂, 140₃ may each be connected to different tracks 32₁, 32₂, 32₃ of the PCB 30 and/or to different port busbars 40₁, 40₂, 40₃. The first busbar 140₁ is physically and/or electrically connected (e.g., directly) to the first track 32₁ of the PCB 30 and is electrically connected to the first port busbar 40₁ via the first track 32₁ and/or the PCB 30. The second busbar 140₂ is physically and/or electrically connected (e.g., directly) to the second track 32₂ of the PCB 30 and is electrically connected to the second port busbar 40₂ via the second track 32₂ and/or the PCB 30. The third busbar 140₃ is physically and/or electrically connected (e.g., directly) to the third track 32₃ of the PCB 30 and is electrically connected to the third port busbar 40₃ via the third track 32₃ and/or the PCB 30.

As generally illustrated in FIG. 2, the busbars 140₁, 140₂, 140₃ of the relay module 100 each include a PCB interface 142₁, 142₂, 142₃ via which the respective busbar 140₁, 140₂, 140₃ is (e.g., directly) connectable and/or connected to the PCB 30 and/or the tracks 32₁, 32₂, 32₃ thereof. In other words, the PCB interface 142₁, 142₂, 142₃ enables the busbar 140₁, 140₂, 140₃ to be directly connected (e.g., soldered) to the PCB 30 and/or the tracks 32₁, 32₂, 32₃ thereof. The busbars and/or terminals of conventional relays lack such an interface and are therefore incapable of being directly connected and/or soldered to a circuit board and must be indirectly connected to the circuit board by additional components and/or structures, such as interconnection busbars. The first busbar 140₁ includes a first PCB interface 142₁, the second busbar 140₂ includes a second PCB interface 142₂, and the third busbar 140₃ includes a third PCB interface 142₃. The busbars 140₁, 140₂, 140₃ of the relay module 100 are each directly connected (e.g., soldered) to the PCB 30 and/or the associated track 32₁, 32₂, 32₃ thereof via their respective PCB interface 142₁, 142₂, 142₃. The busbars 140₁, 140₂, 140₃ of the relay module 100 are therefore connected to the PCB 30 without the use of additional components, such as interconnection busbars, that are common in conventional electrical system designs, which provides the disclosed electrical system 10 and/or module 100 several advantages as described in detail above. The projections 112₁, 112₂, 112₃, 112₄ of the housing 110 are not illustrated in FIG. 2 to provide an unobstructed view of the busbars 140₁, 140₂, 140₃, the PCB interfaces 142₁, 142₂, 142₃, and the electrical contacts 126₁, 128₁, 126₂, 128₂.

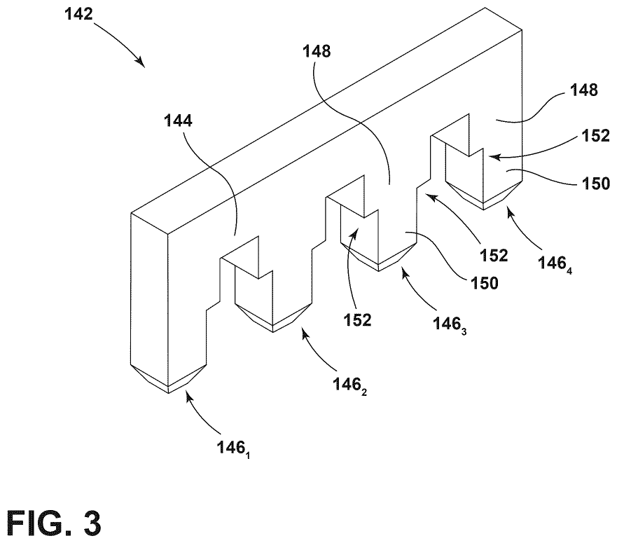

Depicted in FIG. 3 is a PCB interface 142 that is representative of PCB interfaces 142₁, 142₂, 142₃. The PCB interface 142 is a body, structure, and/or formation that is connected to and/or integrally formed with the respective busbar 140₁, 140₂, 140₃. Embodiments of the PCB interface 142 may include a base portion 144 and a plurality of protrusions 146₁, 146₂, 146₃, 146₄ extending from the base portion 144 (e.g., in the same direction), which provides the PCB interface 142 with and/or forms a comb-like shape. The protrusions 146₁, 146₂, 146₃, 146₄ each include a first or wide portion 148 that is directly adjacent to and/or extends from the base portion 144. The protrusions 146₁, 146₂, 146₃, 146₄ each include a second or narrow portion 150 that is narrower than the wide portion 148 and that extends from the wide portion 148 opposite the base portion 144. The wide portion 148 and the narrow portion 150 form and/or define one or more steps 152 and, thus, the protrusions 146₁, 146₂, 146₃, 146₄ may also be referred to and/or claimed as stepped protrusions 146₁, 146₂, 146₃, 146₄. In some examples, such as the one depicted in FIG. 2, the base portion 144 of one or more (e.g., each) of the PCB interfaces 142₁, 142₂, 142₃ is disposed inside of the housing 110 and the protrusions 146₁, 146₂, 146₃, 146₄ project out of the housing 110 (e.g., via a plurality of openings and/or recesses of the housing 110). The protrusions 146₁, 146₂, 146₃, 146₄ are and/or may be directly connectable and/or connected (e.g., solderable and/or soldered) to the PCB 30 and/or the tracks 32₁, 32₂, 32₃ thereof.

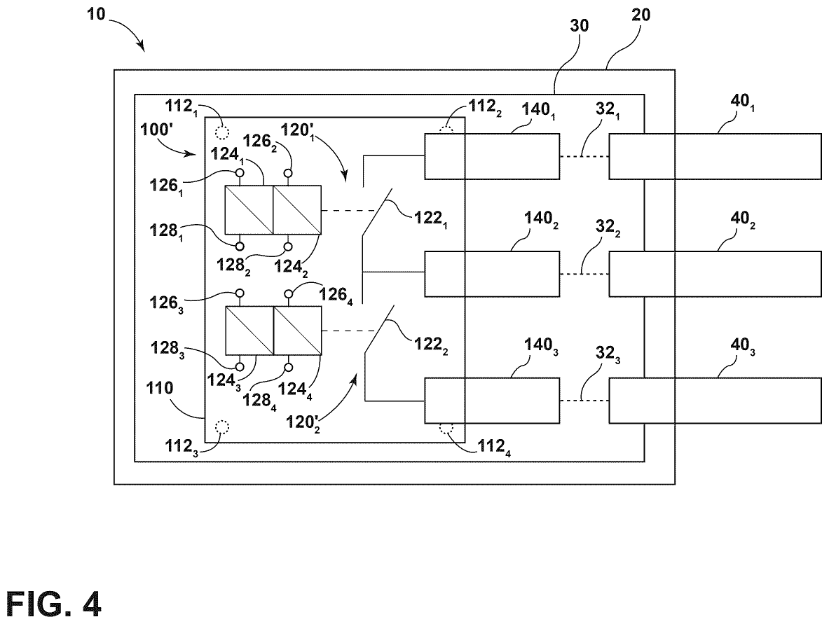

In some embodiments, such as generally illustrated in FIG. 4, one or more relays 120′₁, 120′₂ of the relay module 100′ may be configured as a dual coil bistable latching relay including two actuators (e.g., coils). The relays 120′₁, 120′₂ may be controlled by and connected physically and/or electrically to two or more electrical circuits. In some examples, the relays 120₁, 120₂ are connectable and/or connected to different electrical circuits and are controllable independently of one another by different electrical circuits. The electrical circuits (e.g., the first, second, third, and/or fourth electrical circuits) are each connected to and/or controlled by one or more electronic control units (ECU) (e.g., of a vehicle).

The first relay 120′₁ includes two actuators (e.g., a first actuator 124₁ and a second actuator 124₂), each of which may include and/or be configured as a coil. The first relay 120′₁ and/or the first actuator 124′₁ may include one or more electrical contacts 126₁, 128₁ (e.g., signal terminals) via which the first relay 120′₁ and/or the first actuator 124′₁ is connectable to an electrical circuit (e.g., a first electrical circuit). The first relay 120′₁ and/or the first actuator 124′₁ (e.g., first coil) is disposed and/or included in the first electrical circuit. The first actuator 124′₁ is configured to actuate the first switch 122₁ to adjust the first switch 122₁ to a first state.

The first relay 120′₁ and/or the second actuator 124′₂ may include one or more electrical contacts 126₂, 128₂ (e.g., signal terminals) via which the first relay 120′₁ and/or the second actuator 124′₂ is connectable to an electrical circuit (e.g., a second electrical circuit). The first relay 120′₁ and/or the second actuator 124′₂ (e.g., second coil) is disposed and/or included in the second electrical circuit. The second actuator 124′₂ is configured to actuate the first switch 122₁ to adjust the first switch 122₁ to a second state, which is opposite the first state. In examples, the first state is the open state and the second state is the closed state or, alternatively, the first state is the closed state and the second state is the open state. As such, one of the actuators 124′₁, 124′₂ opens the first switch 122₁ and the other actuator 124′₁, 124′₂ closes the first switch 122₁. The first and/or second actuator 124′₁, 124′₂ may be operated by short voltage pulses and the first switch 122₁ may remain in its current state (e.g., the open state and/or the closed state) until the necessary one of the actuators 124′₁, 124′₂ receives a voltage pulse and adjusts the first switch 122₁ to the other state (e.g., to the open state and/or the closed state).

The second relay 120′₁ includes two actuators (e.g., a third actuator 124₃ and a fourth actuator 124₄), each of which may include and/or be configured as a coil. The second relay 120′₂ and/or the third actuator 124′₃ may include one or more electrical contacts 126₃, 128₃ (e.g., signal terminals) via which the second relay 120′₂ and/or the third actuator 124′₃ is connectable to an electrical circuit (e.g., a third electrical circuit). The second relay 120′₂ and/or the third actuator 124′₃ (e.g., third coil) is disposed and/or included in the third electrical circuit. The third actuator 124′₃ is configured to actuate the second switch 122₂ to adjust the second switch 122₂ to a third state.

The second relay 120′₂ and/or the fourth actuator 124′₄ may include one or more electrical contacts 126₄, 128₄ (e.g., signal terminals) via which the second relay 120′₂ and/or the fourth actuator 124′₄ is connectable to an electrical circuit (e.g., a fourth electrical circuit). The second relay 120′₂ and/or the fourth actuator 124′₄ (e.g., fourth coil) is disposed and/or included in the fourth electrical circuit. The fourth actuator 124′₄ is configured to actuate the second switch 122₂ to adjust the second switch 122₂ to a fourth state, which is opposite the third state. In examples, the third state is the open state and the fourth state is the closed state or, alternatively, the third state is the closed state and the fourth state is the open state. As such, one of the actuators 124′₃, 124′₄ opens the second switch 122₂ and the other actuator 124′₃, 124′₄ closes the second switch 122₂. The third and/or fourth actuator 124′₃, 124′₄ may be operated by short voltage pulses and the second switch 122₂ may remain in its current state (e.g., the open state and/or the closed state) until the necessary one of the actuators 124′₃, 124′₄ receives a voltage pulse and adjusts the second switch 122₂ to the other state (e.g., to the open state and/or the closed state).

The disclosure includes, without limitation, the following embodiments:
1. A high current relay module, comprising: a housing; a plurality of busbars disposed at least partially in the housing; and a plurality of relays disposed in the housing, the plurality of relays including: a first relay via which a first subset of the plurality of busbars are selectively electrically connectable; and a second relay via which a second subset of the plurality of busbars are selectively electrically connectable; and wherein the housing and the plurality of busbars are each connectable to a printed circuit board.
2. The relay module of embodiment 1, wherein: the plurality of busbars includes a first busbar, a second busbar, and a third busbar; the first busbar and the second busbar are selectively electrically connectable via the first relay; and the second busbar and the third busbar are selectively electrically connectable via the second relay.
3. The relay module according to any of the preceding embodiments, wherein: the first relay includes a first switch and a first actuator for actuating the first switch; and the second relay includes a second switch and a second actuator for actuating the second switch.
4. The relay module according to any of the preceding embodiments, wherein the first actuator and the second actuator are operable independently of one another such that a state of the first switch and a state of the second switch are adjustable independently of one another.
5. The relay module according to any of the preceding embodiments, wherein the first actuator includes a first coil and the second actuator includes a second coil.
6. The relay module according to any of the preceding embodiments, wherein the housing includes at least one projection via which the housing is directly connectable to said printed circuit board.
7. The relay module according to any of the preceding embodiments, wherein the plurality of busbars each project out of the housing such that the plurality of busbars are disposed partially inside of the housing and partially outside of the housing.
8. The relay module according to any of the preceding embodiments, wherein the first relay and the second relay are connectable to and controllable independently of one another by different electrical circuits.
9. An electrical system, comprising: the high current relay module according to any of the preceding embodiments; and a printed circuit board; wherein the housing and the plurality of busbars of the relay module are each connected to the printed circuit board.
10. The electrical system of embodiment 9, wherein the housing and the plurality of busbars of the relay module are soldered directly to the printed circuit board.
11. The electrical system according to any of the preceding embodiments, wherein the housing includes at least one projection via which the housing is connected to the printed circuit board.
12. The electrical system according to any of the preceding embodiments, wherein the at least one projection is soldered directly to the printed circuit board.
13. The electrical system according to any of the preceding embodiments, including a plurality of additional busbars that are electrically connected to the plurality of busbars of the relay module via the printed circuit board.
14. The electrical system according to any of the preceding embodiments, including an outer housing in which the relay module, the printed circuit board, and the plurality of additional busbars are disposed.
15. The electrical system according to any of the preceding embodiments, wherein the plurality of additional busbars each project out of the outer housing such that the plurality of additional busbars are disposed partially inside of the outer housing and partially outside of the outer housing.
16. The electrical system according to any of the preceding embodiments, wherein: the plurality of busbars includes a first busbar, a second busbar, and a third busbar; the first busbar and the second busbar are selectively electrically connectable via the first relay; the second busbar and the third busbar are selectively electrically connectable via the second relay; and the plurality of additional busbars includes: a first additional busbar electrically connected to the first busbar of the relay module via the printed circuit board; a second additional busbar electrically connected to the second busbar of the relay module via the printed circuit board; and a third additional busbar electrically connected to the third busbar of the relay module via the printed circuit board.
17. The electrical system according to any of the preceding embodiments, including a first circuit and a second circuit, wherein: the first relay is connected to and controlled by the first circuit; and the second relay is connected to and controlled by the second circuit.
18. The electrical system according to any of the preceding embodiments, wherein: the first relay includes a first switch and a first coil for actuating the first switch; the second relay includes a second switch and a second coil for actuating the second switch; the first coil is included in the first circuit; and the second coil is included in the second circuit.
19. A high current relay module, comprising: a housing including a plurality of projections via which the housing is solderable directly to a printed circuit board; a plurality of busbars disposed at least partially in the housing; and a plurality of individually operable relays disposed in the housing, the plurality of relays each configured to selectively electrically connect a respective subset of the plurality of busbars; wherein the plurality of relays each include a switch and a coil for actuating the switch; and wherein the plurality of busbars each project out of the housing and are solderable directly to said printed circuit board.
20. A high current relay module, comprising: a housing including a plurality of projections via which the housing is connectable to a printed circuit board; a plurality of busbars connectable to said printed circuit board, the plurality of busbars each projecting out of the housing; and a plurality of individually operable relays disposed in the housing, the plurality of relays including: a first relay including a first switch and a first actuator; and a second relay including a second switch and a second actuator; wherein the plurality of busbars includes a first busbar, a second busbar, and a third busbar; wherein the first switch is adjustable, via the first actuator, to i) a closed state in which the first busbar and the second busbar are electrically connected via the first switch and ii) an open state in which the first busbar and the second busbar are not electrically connected via the first switch; and wherein the second switch is adjustable, via the second actuator, to i) a closed state in which the second busbar and the third busbar are electrically connected via the second switch and ii) an open state in which the second busbar and the third busbar are not electrically connected via the second switch.

In examples, an ECU may include an electronic controller and/or include an electronic processor, such as a programmable microprocessor and/or microcontroller. In embodiments, an ECU may include, for example, an application specific integrated circuit (ASIC). An ECU may include a central processing unit (CPU), a memory (e.g., a non-transitory computer-readable storage medium), and/or an input/output (I/O) interface. An ECU may be configured to perform various functions, including those described in greater detail herein, with appropriate programming instructions and/or code embodied in software, hardware, and/or other medium. In embodiments, an ECU may include a plurality of controllers. In embodiments, an ECU may be connected to a display, such as a touchscreen display.

It should be understood that a computer/computing device, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A high current relay module, comprising:
a housing;
a plurality of busbars disposed at least partially in the housing; and
a plurality of relays disposed in the housing, the plurality of relays including:
a first relay via which a first subset of the plurality of busbars are selectively electrically connectable; and
a second relay via which a second subset of the plurality of busbars are selectively electrically connectable; and
wherein the housing and the plurality of busbars are each connectable to a printed circuit board.

2. The relay module of claim 1, wherein:
the plurality of busbars includes a first busbar, a second busbar, and a third busbar;
the first busbar and the second busbar are selectively electrically connectable via the first relay; and
the second busbar and the third busbar are selectively electrically connectable via the second relay.

3. The relay module of claim 1, wherein:
the first relay includes a first switch and a first actuator for actuating the first switch; and
the second relay includes a second switch and a second actuator for actuating the second switch.

4. The relay module of claim 3, wherein the first actuator and the second actuator are operable independently of one another such that a state of the first switch and a state of the second switch are adjustable independently of one another.

5. The relay module of claim 3, wherein the first actuator and the second actuator each include at least one coil.

6. The relay module of claim 1, wherein the housing includes at least one projection via which the housing is directly connectable to said printed circuit board.

7. The relay module of claim 1, wherein the plurality of busbars each project out of the housing such that the plurality of busbars are disposed partially inside of the housing and partially outside of the housing.

8. The relay module of claim 1, wherein the first relay and the second relay are connectable to and controllable independently of one another by different electrical circuits.

9. An electrical system, comprising:
the high current relay module of claim 1; and
a printed circuit board;
wherein the housing and the plurality of busbars of the relay module are each connected to the printed circuit board.

10. The electrical system of claim 9, wherein the housing and the plurality of busbars of the relay module are soldered directly to the printed circuit board.

11. The electrical system of claim 9, wherein the housing includes at least one projection via which the housing is connected to the printed circuit board.

12. The electrical system of claim 11, wherein the at least one projection is soldered directly to the printed circuit board.

13. The electrical system of claim 9, including a plurality of additional busbars that are electrically connected to the plurality of busbars of the relay module via the printed circuit board.

14. The electrical system of claim 13, including an outer housing in which the relay module, the printed circuit board, and the plurality of additional busbars are disposed.

15. The electrical system of claim 14, wherein the plurality of additional busbars each project out of the outer housing such that the plurality of additional busbars are disposed partially inside of the outer housing and partially outside of the outer housing.

16. The electrical system of claim 13, wherein:
the plurality of busbars includes a first busbar, a second busbar, and a third busbar;
the first busbar and the second busbar are selectively electrically connectable via the first relay;
the second busbar and the third busbar are selectively electrically connectable via the second relay; and
the plurality of additional busbars includes:
a first additional busbar electrically connected to the first busbar of the relay module via the printed circuit board;
a second additional busbar electrically connected to the second busbar of the relay module via the printed circuit board; and
a third additional busbar electrically connected to the third busbar of the relay module via the printed circuit board.

17. The electrical system of claim 9, including a first circuit and a second circuit, wherein:
the first relay is connected to and controlled by the first circuit; and
the second relay is connected to and controlled by the second circuit.

18. The electrical system of claim 17, wherein:
the first relay includes a first switch and a first coil for actuating the first switch;
the second relay includes a second switch and a second coil for actuating the second switch;
the first coil is included in the first circuit; and
the second coil is included in the second circuit.

19. A high current relay module, comprising:
a housing including a plurality of projections via which the housing is solderable directly to a printed circuit board;
a plurality of busbars disposed at least partially in the housing; and
a plurality of individually operable relays disposed in the housing, the plurality of relays each configured to selectively electrically connect a respective subset of the plurality of busbars;
wherein the plurality of relays each include a switch and a coil for actuating the switch; and
wherein the plurality of busbars each project out of the housing and are solderable directly to said printed circuit board.

20. A high current relay module, comprising:
a housing including a plurality of projections via which the housing is connectable to a printed circuit board;
a plurality of busbars connectable to said printed circuit board, the plurality of busbars each projecting out of the housing; and
a plurality of individually operable relays disposed in the housing, the plurality of relays including:
a first relay including a first switch and a first actuator; and
a second relay including a second switch and a second actuator;
wherein the plurality of busbars includes a first busbar, a second busbar, and a third busbar;
wherein the first switch is adjustable, via the first actuator, to i) a closed state in which the first busbar and the second busbar are electrically connected via the first switch and ii) an open state in which the first busbar and the second busbar are not electrically connected via the first switch; and
wherein the second switch is adjustable, via the second actuator, to i) a closed state in which the second busbar and the third busbar are electrically connected via the second switch and ii) an open state in which the second busbar and the third busbar are not electrically connected via the second switch.
